(19) United States
(12) Patent Application Publication
(10) Pub. No.: US 2011/0152030 A1
(43) Pub. Date: Jun. 23, 2011

(54) CONICAL FRICTION RING TYPE CONTINUOUSLY VARIABLE TRANSMISSION DEVICE

(75) Inventors: Mitsugi YAMASHITA, Anjo (JP); Shoji TAKAHASHI, Okazaki (JP); Hideyuki UMEDA, Ciryu (JP)

(73) Assignee: AISIN AW CO., LTD., Anjo-shi (JP)

(21) Appl. No.: 12/911,775

(22) Filed: Oct. 26, 2010

(30) Foreign Application Priority Data
Dec. 18, 2009 (JP) 2009-287403

(51) Int. Cl. F16H 15/04

(52) U.S. Cl. 476/7

(57) ABSTRACT

A conical friction ring type CVT device configured with a ring interposed between opposing inclined surfaces of first and second friction wheels so as to surround the first wheel. A portion of the ring is submerged in an oil reservoir, and power is transmitted by contact between the ring and the first and second wheels, such that the ring in moves in the axial direction to steplessly changes speed. When the CVT device is mounted in a vehicle, a rotational direction is set such that, during forward travel of the vehicle, opposing, portions of the first and second wheels move upward from below. An oil strainer is disposed on a side of the second wheel opposite the axis of the first wheel with respect to the axis of the second wheel. Furthermore, a guide member is disposed on at least an upper portion of the second wheel.

### INCORPORATION BY REFERENCE

The disclosure of Japanese Patent Application No. 2009-287403 filed on Dec. 18, 2009 including the specification, drawings and abstract is incorporated herein by reference in its entirety.

### BACKGROUND ART

The present invention relates to a conical friction ring type continuously variable transmission device that has a pair of conical friction wheels disposed mutually parallel and disposed such that a large diameter side and a small diameter side are opposite each other in an axial direction; and a ring that is provided interposed between opposing inclined surfaces of the friction wheels, wherein the ring is moved in the axial direction to steplessly change a speed. More specifically, the present invention relates to an oil strainer that filters oil to be supplied to a contact portion between the ring and the conical friction wheels.

### DESCRIPTION OF THE RELATED ART

A known conical friction ring type continuously variable transmission device (also called a cone ring type continuously variable transmission device) has a conical friction wheel serving as an input side, a conical friction wheel serving as an output side, and a metal ring that is provided interposed between opposing inclined surface of the friction wheels so as to surround the input-side friction wheel. Axes of the friction wheels are disposed parallel, and large diameter portions and small diameter portions of the friction wheels are disposed respectively opposite each other. The cone ring type continuously variable transmission device steplessly changes a speed by moving the ring in an axial direction.

The cone ring type continuously variable transmission device described above transmits power by applying a large axial force that corresponds to a transmission torque or the like under an oil environment such as traction oil, such that a large contact pressure acts on a contact portion between the ring and the friction wheels with an oil film interposed therebetween.

For this reason, the cone ring type continuously variable transmission device is accommodated inside an oil-tight space. A part of the ring and the friction wheels is submerged in oil that is sealed inside the space. Oil is raked up by the rotation of the ring and the friction wheels, and supplied to friction contact portions. A cone ring type continuously variable transmission device that is provided with an oil guide (fluid medium supply body) that guides oil raked up by the rotation of the ring and the friction wheels to the friction contact portions has also been proposed (see Published Japanese Translation of PCT Application No. 2009-506279 (see FIGS. 9 and 10)).

### SUMMARY OF THE INVENTION

In the cone ring type continuously variable transmission device, oil in an oil reservoir is raked up by a rotation member such as a ring, but there is no suggestion of an oil strainer. Particles such as iron powder may be mixed in the oil, requiring the removal of such particles through an oil strainer. However, due to vehicle installation restrictions, it is difficult to dispose the oil strainer while also keeping the continuously variable transmission device compact.

Hence, it is an object of the present invention to provide a conical friction ring type continuously variable transmission device that resolves the above problems by disposing an oil strainer on a side portion of a conical friction wheel (a second conical friction wheel) that is not surrounded by a ring.

According to a first aspect of the present invention, a rotational direction is set such that, during forward travel of the vehicle that takes up the majority of operating time, opposing portions of first and second conical friction wheels move upward from below, and oil raked up from an oil reservoir by a ring or the like is guided to an oil strainer by the second conical friction wheel and a guide member. The oil strainer filters the oil and removes particles such as iron powder. Meanwhile, when the vehicle travels in reverse, the second conical friction wheel reversely rotates. However, since an entire axial length of the second conical friction wheel is not submerged in oil, oil is not sprayed from a lower side of the strainer, and particles settled in the strainer do not spread. Thus, even if particles such as iron powder are mixed in the oil reservoir that is within a space, such particles are removed through use of the continuously variable transmission device. In addition, the strainer is disposed on a side, opposite the first conical friction wheel, of the second conical friction wheel that is not surrounded by the ring, so there is no interference with the ring and a shift operation member that moves the ring.

According to a second aspect of the present invention, the strainer is disposed on a small diameter-side portion in the axial direction of the second conical friction wheel so as to overlap in a radial direction with the second conical friction wheel. Therefore, it is possible to maintain the vehicle mountability of the continuously variable transmission device while also disposing the strainer.

According to a third aspect of the present invention, an axial partial portion on which at least a portion of the oil strainer is disposed corresponds to a portion in the axial direction of the first conical friction wheel that is submerged in oil. Therefore, oil directly raked up by the first conical friction wheel from the oil reservoir is constantly supplied to the oil strainer. Consequently, a relatively large amount of oil in the oil reservoir is continuously circulated, which enables efficient and certain filtering of the oil. In addition, besides the ring, only the axial partial portion of the first conical friction wheel is submerged in the oil reservoir. There is thus little rotational resistance from the oil, and a reduction in transmission efficiency due to power loss can be decreased.

According to a fourth aspect of the present invention, a case that surrounds the second conical friction wheel is disposed, and the case having one of a conical shape and a cylindrical shape guides so as to lead oil to the second conical friction wheel. Therefore, a supply of oil to the oil strainer can be secured without requiring a special guide member. In addition, the case, and therefore, the cone ring type continuously variable transmission device can be made more compact.

According to a fifth aspect of the present invention, the second conical friction wheel is an output-side friction wheel. A state in which the ring moves and transmits power on the small diameter-side portion of the second conical friction wheel is an acceleration (O/D) side where there is a small load torque. Therefore, the load torque is in a small region when oil raked up by the ring is filtered in the oil strainer, and the impact of power loss is also in a small region.

According to a sixth aspect of the present invention, a traction oil is provided interposed between the contact surfaces of the conical friction wheel and the ring, and torque can be reliably transferred through a shear force of the traction oil in an extreme pressure condition. Once a rotation member is dipped in the traction oil, a large shear resistance is generated between the rotation member and the traction oil. However, the portion of the rotation member submerged in the traction oil is minimized to an axial portion on the large diameter side of the first conical friction wheel on the outside of the ring. Therefore, there is little power loss due to oil resistance.

### BRIEF DESCRIPTION OF THE DRAWINGS

FIG. 1 is an interior cross-sectional view that shows a hybrid drive system to which the present invention is applied;

FIG. 2 is a plane view that shows a conical friction ring (cone ring) type continuously variable transmission device according to the present invention;

FIG. 3 is a side view of the conical friction ring (cone ring) type continuously variable transmission device;

FIG. 4 is a frontal view of the conical friction ring (cone ring) type continuously variable transmission device;

FIG. 5 is a side view of the partially modified conical friction ring (cone ring) type continuously variable transmission device; and

FIG. 6 is a side view of the further modified conical friction ring (cone ring) type continuously variable transmission device.

### DETAILED DESCRIPTION OF THE EMBODIMENT

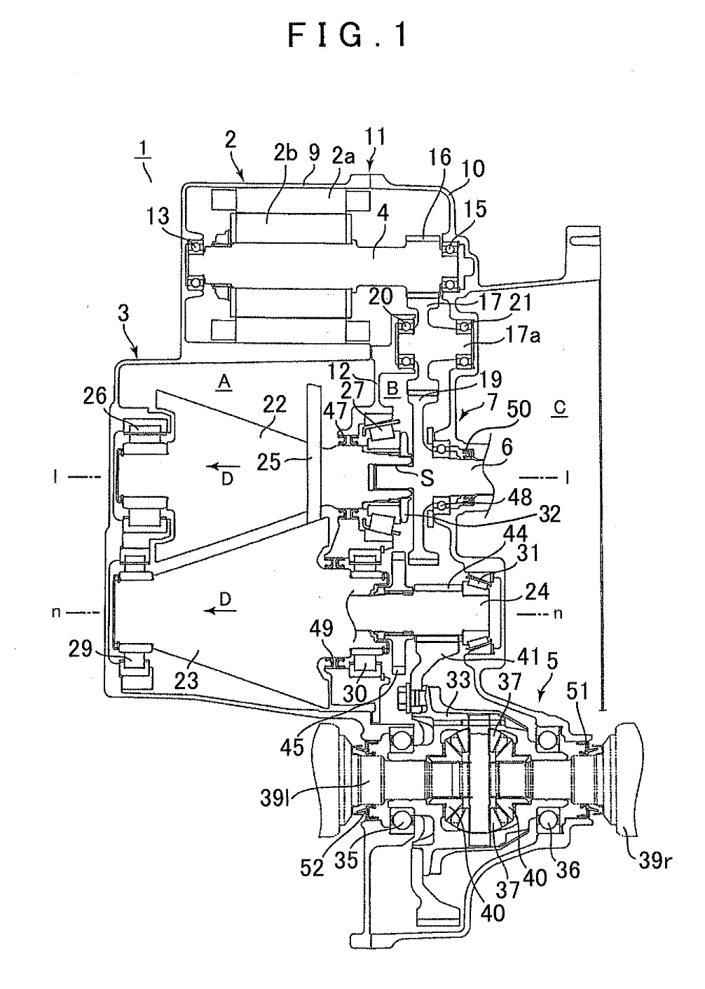

A hybrid drive system to which the present invention is applied will be described below with reference to the attached drawings. As shown in FIG. 1, a hybrid drive system 1 includes an electric motor 2, a cone ring type continuously variable transmission device (a conical friction ring type continuously variable transmission device) 3, a differential device 5, an input shaft 6 that moves in accordance with an output shaft of an engine (not shown), and a gear transmission device 7. The above devices and shafts are housed in a case 11 that is formed by two case members, that is, a case member 9 and a case member 10. Further, the case 11 includes a first space A and a second space B divided by a partition 12 in an oil-tight manner.

The electric motor 2 includes a stator 2a fixed to the first case member 9, and a rotor 2b provided on an output shaft 4. A first-side end portion of the output shaft 4 is rotatably supported by the first case member 9 through a bearing 13, and a second-side end portion of the output shaft 4 is rotatably supported by the second case member 10 through a bearing 15. An output gear 16 consisting of a toothed gear (pinion) is formed on a second side of the output shaft 4, and meshes with an intermediate gear (toothed gear) 19 provided on the input shaft 6 through a toothed idler gear 17.

A shaft 17a of the toothed idler gear 17 includes a first-side end portion that is rotatably supported by the partition 12 through a bearing 20, and a second-side end portion that is rotatably supported by the second case member 10 through a bearing 21. The toothed idler gear 17 is disposed partially overlapping with the electric motor 2 in a radial direction when viewed from the side (that is, when viewed in an axial direction).

The cone ring type continuously variable transmission device 3 includes a conical (first conical) friction wheel 22 serving as an input member, a conical (second conical) friction wheel 23 serving as an output member, and a ring 25 made of metal. The friction wheels 22, 23 are disposed such that axes l-l, n-n thereof are mutually parallel, and a small diameter side and a large diameter side of the friction wheel 22 are disposed axially opposite to a small diameter side and a large diameter side of the friction wheel 23. The ring 25 is interposed between opposing inclined surfaces of the friction wheels 22, 23 and surrounds one of the friction wheels, for example, the input-side friction wheel 22. A large thrust force acts on at least one of the friction wheels, and therefore the ring 25 is interposed between the inclined surfaces by a relatively large clamping force based on this thrust force. Specifically, an axial force application mechanism (not shown) formed of a wave-like cam is formed between the output-side friction wheel 23 and an output shaft 24 of the continuously variable transmission device, on surfaces opposed to each other in the axial direction. The thrust force in a direction shown by an arrow D is generated in accordance with the transferred torque on the output-side friction wheel 23, and a large clamping force is generated to act on the ring 25 between the output-side friction wheel 23 and the input-side friction wheel 22 that is supported in a direction that counters the thrust force.

The input-side friction wheel 22 includes a first-side (large diameter-side) end portion supported by the first case member 9 through a roller bearing 26, and a second-side (small diameter-side) end portion supported by the partition 12 through a tapered roller bearing 27. The output-side friction wheel 23 includes a first-side (small diameter-side) end portion supported by the first case member 9 through a roller (radial) bearing 29, and a second-side (large diameter-side) end portion supported by the partition 12 through a roller (radial) bearing 30. The output shaft 24, which applies to the output-side friction wheel 23 the thrust force acting in the direction shown by the arrow D as described above, includes a second-side end supported by the second case member 10 through a tapered roller bearing 31. An inner race of the bearing 27 is interposed between a stepped portion and a nut 32 on the second-side end portion of the input-side friction wheel 22, and the thrust force that acts on the input-side friction wheel 22 through the ring 25 in the direction shown by the arrow D from the output-side friction wheel 23 is supported by the tapered roller bearing 27. On the other hand, a reaction force of the thrust force acting on the output-side friction wheel 23 acts on the output shaft 24 in a direction opposite to the direction shown by the arrow D, and the reaction force of the thrust force is supported by the tapered roller bearing 31.

The ring 25 moves in the axial direction by an axial moving mechanism (a shift operation member), such as a ball screw, and changes the positions of contact with the input-side friction wheel 22 and the output-side friction wheel 23, so as to steplessly change the speed by steplessly changing a rotation ratio between the input member 22 and the output member 23. The thrust force D corresponding to the transferred torque and the reaction force of the thrust force are canceled out by the tapered roller bearings 27, 31 in the integrated case 11, and an equilibrant force such as a hydraulic pressure is not required.

The differential device 5 includes a differential case 33, and the differential case 33 includes a first-side end portion supported by the first case member 9 through a bearing 35, and a second-side end portion supported by the second case member 10 through a bearing 36. A shaft that is perpendicular to the axial direction is attached to the inside of the differential case 33, and bevel gears 37, 37, which serve as differential carriers, are engaged with the shaft. Left and right axle shafts 39l, 39r are supported by the shaft, and bevel gears 40, 40 that mesh with the differential carriers are fixed to the axle shafts. Further, a differential ring gear (toothed gear) 41 having a large diameter is attached to the outside of the differential case 33.

The output shaft 24 of the continuously variable transmission device is formed with a gear (pinion) 44, and the toothed gear 44 meshes with the differential ring gear 41. The motor output gear (pinion) 16, the toothed idler gear 17, the intermediate gear (toothed gear) 19, the output gear (pinion) 44 of the continuously variable transmission device, and the differential ring gear (toothed gear) 41 constitute the gear transmission device 7. The motor output gear 16 and the differential ring gear 41 are disposed overlapping each other in the axial direction, and the intermediate gear 19 and the output gear 44 of the continuously variable transmission device are disposed overlapping the motor output gear 16 and the differential ring gear in the axial direction. Note that, a gear 45, which is engaged with the output shaft 24 of the continuously variable transmission device through a spline, is a parking gear that locks the output shaft when a shift lever is in a parking position. Further, the term “gear” refers to a meshing rotary transmission mechanism including toothed gears and sprockets. In this embodiment, however, the gear transmission device is a toothed gear transmission device that is formed by toothed gears only.

The input shaft 6 is supported by the second case member 10 through a roller bearing 48. A first end of the input shaft 6 is engaged (drivingly connected) with the input member 22 of the continuously variable transmission device 3 through a spline S, and a second end side of the input shaft 6 is linked with the output shaft of the engine through a clutch (not shown) housed in a third space C defined by the second case member 10, so that the input shaft 6 moves in accordance with the output shaft of the engine. The second case member 10 is open and connected to the engine (not shown) on a third space C side.

The gear transmission device 7 is housed in the second space B. The second space B is a space between the third space C, and the electric motor 2 and the first space A, in the axial direction. The second space B is defined by the second case member 10 and the partition 12. The shaft-supporting portions (27, 30) of the partition 12 are placed in an oil-tight state by oil seals 47, 49, respectively, and the shaft-supporting portions of the second case member 10 and the first case member 9 are shaft-sealed by oil seals 50, 51, 52. The second space 13 is configured to be oil-tight, and is filled with a predetermined amount of a lubricant oil such as ATF. The first space A defined by the first case member 9 and the partition 12 is similarly configured to be oil-tight, and is filled with a predetermined amount of a traction oil having a shear force, and a large shear force under an extreme pressure condition in particular.

Next, the operation of the hybrid drive system 1 as described above will be explained. The hybrid drive system 1 is connected to an internal combustion engine on the third space C side of the case 11, and the output shaft of the engine is connected to the input shaft 6 through a clutch. The power from the engine is transmitted to the input shaft 6, and the rotation of the input shaft 6 is transmitted to the input-side friction wheel 22 in the cone ring type continuously variable transmission device 3 through the spline S. The power is further transmitted to the output-side friction wheel 23 through the ring 25.

During this transmission, a large contact pressure acts between the friction wheels 22, 23 and the ring 25 due to the thrust force acting on the output-side friction wheel 23 in the direction shown by the arrow D. Because the first space A is filled with the traction oil, an oil film of the traction oil is formed between the friction wheels and the ring, bringing about the extreme pressure condition. In this condition, the traction oil has a large shear force, and thus the power is transmitted between the friction wheels and the ring by the shear force of the oil film. This allows the transfer of a predetermined torque in a non-slip manner without causing wear on the friction wheels and the ring, even though the torque transfer is made through contact between metal members. Moreover, the ring 25 moves in the axial direction smoothly to change the positions of contact between both friction wheels and the ring, whereby the speed is steplessly changed.

The rotation of the output-side friction wheel 23 whose speed has been steplessly changed is transmitted to the differential case 33 of the differential device 5 through the output shaft 24, the output gear 44, and the differential ring gear 41. The power is then distributed to the left and right axle shafts 39l, 39r so as to drive the vehicle wheels (front wheels).

On the other hand, the power from the electric motor 2 is transmitted to the input shaft 6 through the output gear 16, the toothed idler gear 17, and the intermediate gear 19. Similar to the description above, the speed of the rotation of the input shaft 6 is steplessly changed by the cone ring type continuously variable transmission device 3, and the rotation is transmitted to the differential device 5 through the output gear 44 and the differential ring gear 41. The gear transmission device 7 formed by the gears 16, 17, 19, 44, 41, 37, 40 is housed in the second space B filled with the lubricant oil, and therefore the power is smoothly transmitted through the lubricant oil when the gears mesh. At such time, because the differential ring gear 41 disposed at a lower position in the second space B is formed of a large diameter gear, the differential ring gear 41 rakes up the lubricant oil so that a sufficient amount of lubricant oil is reliably supplied to the other gears (toothed gears) 16, 17, 19, 44 and the bearings 27, 30, 20, 21, 31, 48.

Various operation modes of the engine and the electric motor, that is, operation modes as the hybrid drive system 1, may be employed as necessary. As an example, when the vehicle starts off, the clutch is disconnected and the engine stopped so that the vehicle is started using only the torque from the electric motor 2. Once the vehicle speed reaches a predetermined speed, the engine is started and the vehicle is accelerated by the power from the engine and the electric motor. When the vehicle speed becomes a cruising speed, the electric motor goes into free rotation or is placed in a regeneration mode, and the vehicle travels using only the power from the engine. During deceleration or braking, the electric motor regenerates to charge a battery. Further, the vehicle may be started by the power from the engine using the clutch as a starting clutch, with the torque from the motor used as an assisting power.

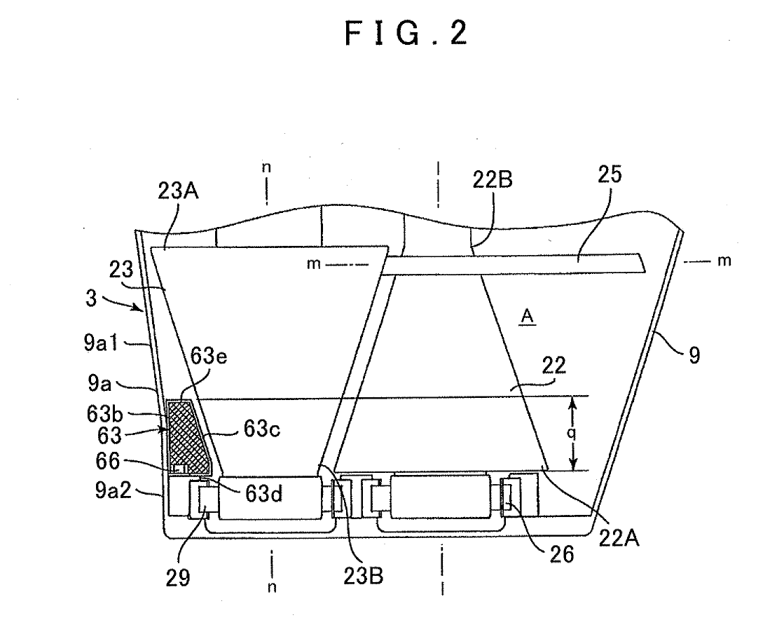

Next, the conical friction ring (cone ring) type continuously variable transmission device 3 according to the present invention will be described with reference to FIGS. 2, 3, and 4. As explained earlier, the continuously variable transmission device 3 includes the input-side friction wheel 22, the output-side friction wheel 23, and the ring 25. Both friction wheels and the ring are formed from a metal such as steel. The friction wheels 22, 23 are disposed such that the axes l-l, n-n thereof are horizontal and mutually parallel, and have conical shapes whose inclined surfaces are linear. The ring 25 is provided interposed between opposing inclined surfaces. The ring 25 is disposed so as to surround one of the friction wheels, specifically, the input-side (first conical) friction wheel 22. A cross section of the ring 25 on a perpendicular plane to a circumferential direction thereof is substantially a parallelogram, and a rotational plane m-m of the ring 25 is set so as to be generally perpendicular to the axis l-l.

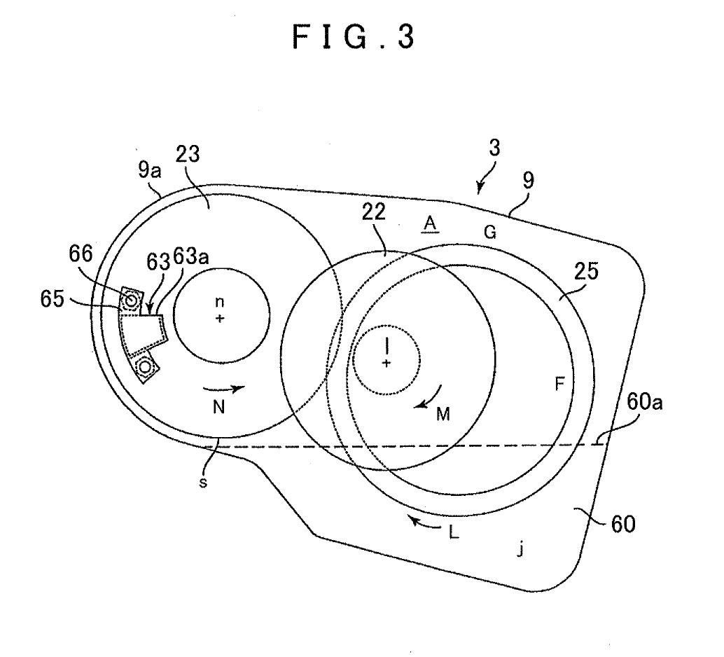

The cone ring type continuously variable transmission device 3 is accommodated in an oil-tight manner in the first space A with one end side and an entire circumferential side thereof covered by the bottomed cylindrical first case member 9, and an opening side of the first case member 9 closed by the partition 12. Both friction wheels are arranged staggered such that the axis n-n of the output-side (second conical) friction wheel 23 is positioned above the axis l-l of the input-side (first conical) friction wheel 22 by a predetermined amount. The input-side friction wheel 22 is disposed with play thereabove and therebelow, and with play between it and the case member 9 on a side opposite the output-side friction wheel 23. The ring 25 surrounding the input-side friction wheel 22, as shown in FIG. 3, is disposed in a space between the input-side friction wheel and the case member 9, and the shift operation member (not shown) that moves the ring 25 in the axial direction is disposed spanning from a side space F and an upper space G.

A lower space J between the case member 9 and the input-side friction wheel 22 is an oil reservoir 60 (whose oil level is indicated by reference numeral 60a) for traction oil. The case member 9 extends along the output-side friction wheel so as to substantially surround three surfaces (an upper surface, a lower surface, and a side surface, excluding an input-side friction wheel side in FIG. 3) of the output-side (second conical) friction wheel 23. An output-side friction wheel portion 9a of the case member 9 has an angle δ that is smaller than an inclination angle of the conical output-side friction wheel 23, and is formed of a conical shape 9a1 in a direction following the conical friction wheel and a cylindrical shape 9a2 on a distal end side thereof. Accordingly, the output-side friction wheel portion 9a of the case is disposed along the friction wheel, and constitutes a guide member that guides raked up oil. The output-side friction wheel 23 is disposed such that a lower end s of a conical maximum diameter portion of the output-side friction wheel 23 is positioned above the oil level 60a, and such that the entire axial length of the output-side friction wheel 23 does not become submerged in the oil reservoir 60.

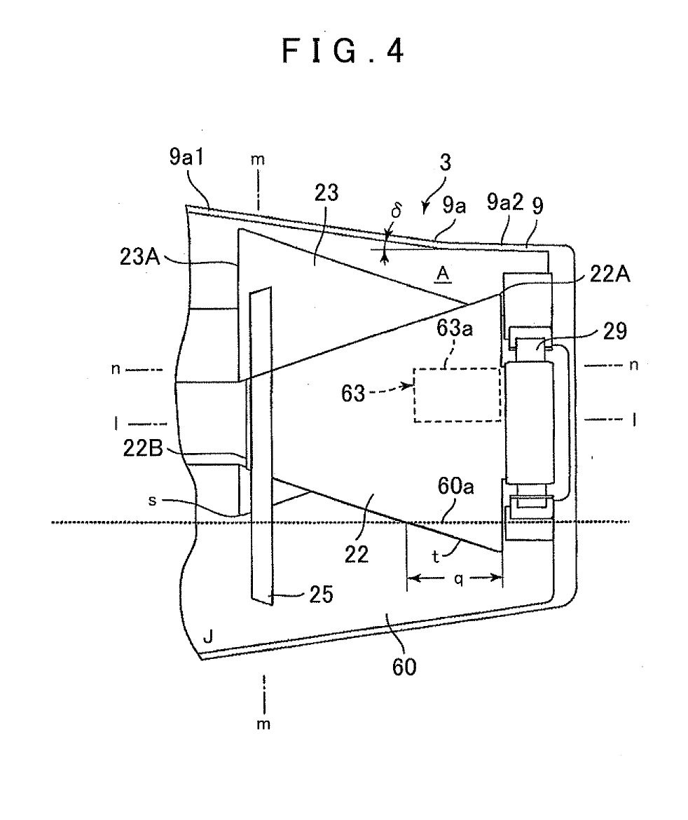

Meanwhile, as FIG. 4 shows in detail, the input-side friction wheel 22 is disposed such that a small diameter side 22B of the input-side friction wheel 22 is positioned above the oil level 60a over a predetermined length, and a large diameter-side portion 22A of the input-side friction wheel 22 becomes submerged in the oil reservoir 60. For example, the conical input-side friction wheel 22 is dipped in the oil reservoir 60 such that 50 to 65% of the entire length from the small diameter side thereof is positioned above the oil level 60a and 50 to 35% of the large diameter side is submerged in the oil reservoir 60. An oil strainer 63 according to the present invention is disposed on the small diameter-side portion of the output-side (second conical) friction wheel 23 that corresponds to an axial partial portion q submerged in the oil reservoir 60 of the input-side friction wheel 22. In other words, the oil strainer 63 is disposed on the side of the output-side friction wheel 23 opposite the axis l-l of the input-side friction wheel 22 with respect to the axis n-n of the output-side friction wheel 23, so as to extend within an axial length that corresponds to the axial partial portion q that is submerged in the oil reservoir 60 on the large diameter side of the input-side friction wheel 22. Given that it is the small diameter side, there is play between the case member 9a and the small diameter-side portion of the output-side friction wheel 23 on which the oil strainer 63 is disposed. There is also no interference with the ring 25 and the shift operation member that moves the ring, which are both disposed in the spaces G, F. Consequently, sufficient installation space for the shift operation member is secured.

The oil strainer 63 is fixed by a bracket 65 and a bolt 66 to an inner side of the case member 9, and formed of a box-like mesh with an upward opening (63a). Oil is introduced from the upward opening 63a, and particles such as iron powder are filtered by the mesh as the oil passes through and drips down. As shown in FIG. 2, on the small diameter side 23B portion of the output-side friction wheel 23, an outward-side surface 63b of the oil strainer 63 is in close contact with a cylindrical portion 9a2 of the case member and an inward-side surface 63c of the oil strainer 63 is disposed so as to follow the inclined surface of the conical friction wheel 23. The oil strainer 63 is also disposed such that a distal-side end surface 63d thereof aligns with the small diameter-side 23B end of the conical friction wheel 23, and a length of an opposite end surface 63e thereof is slightly shorter than or aligns with the axial partial portion q. The width of the oil strainer 63 is set such that the oil strainer 63 at least partially overlaps with the output-side friction wheel 23 in the radial direction; the oil strainer 63 (the outward-side surface 63b) is preferably disposed so as to fit within an inner diameter side of a maximum diameter side 23A of the output-side friction wheel 23 as viewed from the axial direction. As shown in FIG. 3, in the present embodiment, the upper end opening face 63a of the strainer 63 is disposed so as to substantially align with the axis n-n.

In the present conical friction ring (cone ring) type continuously variable transmission device 3, torque is transmitted from the input-side (first conical) friction wheel 22 to the output-side (second conical) friction wheel 23 through the ring 25. The ring 25 is moved in the axial direction by the shift operation member (not shown) to steplessly change a speed by changing a friction contact position of the friction wheels 22, 23. In addition, traction oil is interposed at the friction contact position, and torque is transmitted through the shear force of the oil under an extreme pressure condition. When the vehicle travels forward, the rotation of the input-side friction wheel 22 in an arrow M direction causes the ring 25 to rotate in an arrow L direction, and the output-side friction wheel 23 to rotate in an arrow N direction. In other words, during forward travel of the vehicle, the input-side and output-side friction wheels 22, 23 rotate such that opposing portions thereof move upward from below.

Oil raked up from the oil reservoir 60 by a rotation member is supplied to the friction contact surface between the ring 25 and the friction wheels 22, 23. A lower portion of the ring 25 is fully submerged in the oil reservoir 60. Consequently, the ring 25 is sufficiently cooled, and the rotation of the ring 25 in the arrow L direction causes the oil in the oil reservoir 60 to be lifted up and around, and carried to the contact portion between the ring 25 and the friction wheels 22, 23.

Oil taken up by the ring 25 is scattered toward the output-side friction wheel 23 due to a centrifugal force. A portion of the oil adhered to the output-side friction wheel 23 is guided to the case member 9a constituting the guide member and subsequently drips down into the strainer 63, and the remaining oil adhered to the output-side friction wheel 23 is also guided to the strainer 63 due to the centrifugal force.

Meanwhile, the large diameter-side partial portion q of the input-side friction wheel 22 that corresponds in the axial direction to the oil strainer 63 is submerged in the oil reservoir 60. Due to the rotation in the arrow M direction of the input-side friction wheel 22, oil from the oil reservoir 60 is directly raked up and introduced to the output-side friction wheel 23, and similarly guided to the oil strainer 63.

Accordingly, although the entire axial length of the output-side friction wheel 23 is not submerged in the oil reservoir 60, as described earlier, the output-side friction wheel 23 is at a position easily subjected to oil adhered to the ring 25 due to the centrifugal force. In addition, oil is directly raked up by the axial partial portion q on the large diameter side, which is submerged in the oil reservoir 60, of the input-side friction wheel 22. Such oil is scattered by the rotation in the arrow N direction of the output-side friction wheel 23, three sides of which are surrounded by the case member 9a, and subsequently guided by the case member 9a constituting the guide member and introduced to the opening 63a of the oil strainer 63. Particles such as iron powder mixed in the oil are filtered out by the oil strainer 63 as the oil passes through the mesh and returns to the oil reservoir 60 again. The particles settle and accumulate at a lower portion of the oil strainer 63.

When the vehicle backs up, the cone ring type continuously variable transmission device 3 reversely rotates, which means that the output-side friction wheel 23 also rotates in a direction opposite to the arrow N. The entire axial length of the output-side friction wheel 23 is not submerged in the oil reservoir 60. Therefore, the reverse rotation of the output-side friction wheel 23 does not cause oil to spray from the bottom of the strainer 63 and particles settled in the strainer 63 to spread. Thus, with the use of the cone ring type continuously variable transmission device 3, particles in oil are filtered out and accumulated by the strainer 63. In addition, the oil strainer 63 is disposed in dead space on the small diameter side of the output-side friction wheel 23 so that the continuously variable transmission device 3 can be kept compact, and the case member surrounding the output-side friction wheel 23 can also be used as the guide member that guides oil to the oil strainer. Further, only a portion of the large diameter side of the input-side friction wheel 22 and the ring 25 is submerged in the oil reservoir 60. Thus, the oil shear resistance with respect to the rotation member is small, power loss is small, and there is little reduction in transmission efficiency.

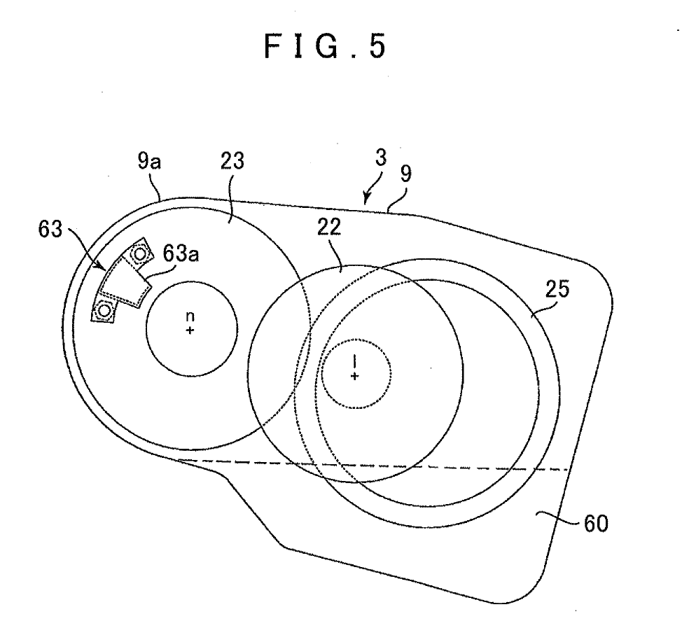

FIG. 5 shows an embodiment with the oil strainer 63 disposed such that the upward opening face 63a is above a horizontal plane of the axis n-n of the output-side friction wheel 23.

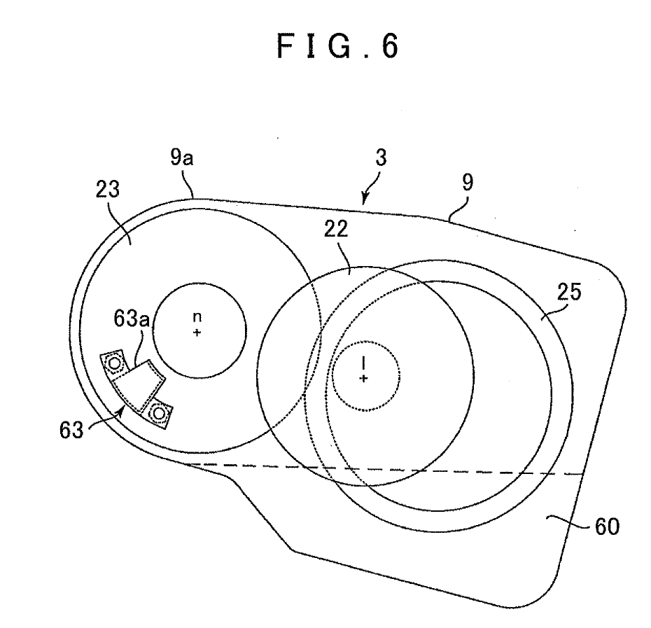

FIG. 6 shows an embodiment with the oil strainer 63 disposed such that the upward opening face 63a is below the horizontal plane of the axis n-n of the output-side friction wheel 23. Both of these embodiments use the same reference numerals and will not be described further here.

The above description concerns an embodiment in which the continuously variable transmission device is applied to a hybrid drive system. However, the present invention is not limited to this, and may be applied to a drive system other than a hybrid drive system, wherein, for example, another type of gear transmission device, such as a gear transmission device that serves as a reverse gear transmission device, or a planetary gear that separates and transfers a part of torque and combines the torque with an output from the continuously variable transmission device, may be used so as to expand the shift range of the continuously variable transmission device or distribute a part of the transferred torque. The present invention may also be used in a singular continuously variable transmission device. In such case, the present invention is preferably applied to transport machinery for an automobile or the like, but may be used in other power transmission devices for industrial machinery or the like as well.

The conical friction ring type continuously variable transmission device according to the present invention may be utilized as a power transmission device for running and driving an automobile, and is particularly well suited for application to a hybrid drive system.

What is claimed is:

1. A conical friction ring type continuously variable transmission device comprising:
first and second conical friction wheels that are disposed on mutually parallel axes inside an oil-tight space and disposed such that a large diameter side and a small diameter side are opposite each other in an axial direction; and
a ring that is provided interposed between opposing inclined surfaces of the first and second friction wheels so as to surround the first conical friction wheel, wherein
a portion of the ring is submerged in an oil reservoir in a lower portion of the space, power is transmitted by contact between the ring and the first and second conical friction wheels with oil interposed therebetween, and moving the ring in the axial direction steplessly changes a speed,
the conical friction ring type continuously variable transmission device is mounted in a vehicle, and a rotational direction is set such that, during forward travel of the vehicle, opposing portions of the first and second conical friction wheels move upward from below,
the axis of the second conical friction wheel is in a horizontal direction and positioned above the axis of the first conical friction wheel, and a lower end of a maximum diameter side of the second conical friction wheel is disposed so as to be positioned above an oil level of the oil reservoir,
an oil strainer, which filters by allowing oil raked up from the oil reservoir to pass through, is disposed on a side of the second conical friction wheel opposite the axis of the first conical friction wheel with respect to the axis of the second conical friction wheel, and
a guide member that guides oil raked up by the ring toward the oil strainer is disposed on at least an upper portion of the second conical friction wheel.

2. The conical friction ring type continuously variable transmission device according to claim 1, wherein
the oil strainer is disposed on a small diameter-side portion in the axial direction of the second conical friction wheel so as to at least partially overlap in a radial direction with the second conical friction wheel.

3. The conical friction ring type continuously variable transmission device according to claim 1, wherein
the first conical friction wheel has a portion in the axial direction on the large diameter side thereof submerged in the oil reservoir, and
at least a portion of the oil strainer is disposed within an axial partial portion on the small diameter side of the second conical friction wheel that corresponds to the portion in the axial direction of the first conical friction wheel.

4. The conical friction ring type continuously variable transmission device according to claim 1, wherein
a case that constitutes the space that accommodates the second conical friction wheel is formed into one of a conical shape and a cylindrical shape so as to surround the second conical friction wheel, and
the guide member is the case that surrounds the second conical friction wheel.

5. The conical friction ring type continuously variable transmission device according to claim 1, wherein
the first conical friction wheel is an input-side friction wheel, and the second conical friction wheel is an output-side friction wheel.

6. The conical friction ring type continuously variable transmission device according to claim 1, wherein
the oil is a traction oil.

7. The conical friction ring type continuously variable transmission device according to claim 2, wherein
the first conical friction wheel has a portion in the axial direction on the large diameter side thereof submerged in the oil reservoir, and
at least a portion of the oil strainer is disposed within an axial partial portion on the small diameter side of the second conical friction wheel that corresponds to the portion in the axial direction of the first conical friction wheel.

8. The conical friction ring type continuously variable transmission device according to claim 7, wherein
a case that constitutes the space that accommodates the second conical friction wheel is formed into one of a conical shape and a cylindrical shape so as to surround the second conical friction wheel, and
the guide member is the case that surrounds the second conical friction wheel.

9. The conical friction ring type continuously variable transmission device according to claim 8, wherein
the first conical friction wheel is an input-side friction wheel, and the second conical friction wheel is an output-side friction wheel.

10. The conical friction ring type continuously variable transmission device according to claim 9, wherein
the oil is a traction oil.

11. The conical friction ring type continuously variable transmission device according to claim 2, wherein
a case that constitutes the space that accommodates the second conical friction wheel is formed into one of a conical shape and a cylindrical shape so as to surround the second conical friction wheel, and
the guide member is the case that surrounds the second conical friction wheel.

12. The conical friction ring type continuously variable transmission device according to claim 2, wherein
the first conical friction wheel is an input-side friction wheel, and the second conical friction wheel is an output-side friction wheel.

13. The conical friction ring type continuously variable transmission device according to claim 3, wherein
a case that constitutes the space that accommodates the second conical friction wheel is formed into one of a conical shape and a cylindrical shape so as to surround the second conical friction wheel, and
the guide member is the case that surrounds the second conical friction wheel.

14. The conical friction ring type continuously variable transmission device according to claim 3, wherein
the first conical friction wheel is an input-side friction wheel, and the second conical friction wheel is an output-side friction wheel.

15. The conical friction ring type continuously variable transmission device according to claim 4, wherein
the first conical friction wheel is an input-side friction wheel, and the second conical friction wheel is an output-side friction wheel.

16. The conical friction ring type continuously variable transmission device according to claim 7, wherein
the first conical friction wheel is an input-side friction wheel, and the second conical friction wheel is an output-side friction wheel.

17. The conical friction ring type continuously variable transmission device according to claim 11, wherein
the first conical friction wheel is an input-side friction wheel, and the second conical friction wheel is an output-side friction wheel.

18. The conical friction ring type continuously variable transmission device according to claim 13, wherein
the first conical friction wheel is an input-side friction wheel, and the second conical friction wheel is an output-side friction wheel.

19. The conical friction ring type continuously variable transmission device according to claim 2, wherein
the oil is a traction oil.

20. The conical friction ring type continuously variable transmission device according to claim 3, wherein
the oil is a traction oil.
